(19) United States
(12) Patent Application Publication
(10) Pub. No.: US 2013/0300328 A1
(43) Pub. Date: Nov. 14, 2013

(54) SWITCHING CONTROL APPARATUS FOR TWO PHASE SWITCHED RELUCTANCE MOTOR AND METHOD THEREOF

(71) Applicants: Se Joo Kim, Gyunggi-do (KR); Han Kyung BAE, Gyunggi-do (KR); Hyung Joon KIM, Gyunggi-do (KR); Hong Chul SHIN, Gyunggi-do (KR)

(72) Inventors: Se Joo Kim, Gyunggi-do (KR); Han Kyung BAE, Gyunggi-do (KR); Hyung Joon KIM, Gyunggi-do (KR); Hong Chul SHIN, Gyunggi-do (KR)

(73) Assignee: SAMSUNG ELECTRO-MECHANICS CO., LTD., Gyunggi-do (KR)

(21) Appl. No.: 13/600,473

(22) Filed: Aug. 31, 2012

(30) Foreign Application Priority Data
May 11, 2012 (KR) 10-2012-0050351

(51) Int. Cl. H02P 6/14

(52) U.S. Cl. 318/400.27

(57) ABSTRACT

Disclosed herein are a switching control apparatus for two phase switched reluctance motor and a method thereof. The switching control apparatus includes a rectifier rectifying commercial power; and an active converter including a pair of common switches commonly connected to two phase windings of two phase SRMs, a pair of first phase switches bridge-connected to the pair of common switches at any one of the two phase windings, a pair of second phase switches bridge-connected to the pair of common switches at the other one of the two phase windings, and a plurality of current feedback diodes each connected to the switches, wherein the active converter is operated in operation modes 1 to 3 to drive the two phase SRM.

### CROSS REFERENCE TO RELATED APPLICATION

This application claims the benefit of Korean Patent Application No. 10-2012-0050351, filed on May 11, 2012, entitled “Switching Control Apparatus For Two Phase Switched Reluctance Motor And Method Thereof”, which is hereby incorporated by reference in its entirety into this application.

### BACKGROUND OF THE INVENTION

1. Technical Field

The present invention relates to a switching control apparatus for a two phase switched reluctance motor and a method thereof.

2. Description of the Related Art

A switched reluctance motor (hereinafter, referred to as SRM) is a motor with which a switching control apparatus is coupled and includes a stator and a rotor having a salient pole type structure.

In particular, only a stator portion is wound with a winding and a rotor portion does not have any type of windings or permanent magnets and therefore, a structure of a motor is simplified.

Due to the characteristics of the structure, it is significantly advantageous in manufacturing and production. The switched reluctance motor has excellent characteristics such as good starting property and torque like a DC motor, little maintenance, torque per one unit volume, efficiency, rating of a converter, or the like. Therefore, the switched reluctance motor has been widely applied to various applications.

There are various types of switched reluctance motors such as a single phase, a two phase, a three phase, and the like. In particular, the two-phase SRM has been significantly interested in applications, such as a fan, a blower, a compressor, and the like, by having a simpler driving circuit than that of the three-phase SRM.

Further, the switching control apparatus for the two phase SRM has used various methods for controlling current of a stator winding in one direction. There is the switching control apparatus using an asymmetric bridge converts for driving the existing AC motor using the used types.

The asymmetric bridge converter has two switches and diodes and has a three-stage operation mode.

Herein, operation mode 1 is a mode that turns-on two switches to apply DC power supply voltage to a winding and increase current, operation mode 2 is a mode that turns-off one of the two switches when current flows in a winding to circulate current to one diode and switch and a winding and slowly reduce current, and operation mode 3 is a mode that simultaneously turns-off two switches to rapidly reduce current.

The asymmetric bridge converter operated as described above have the most excellent diversity of control among converters for driving an SRM and independently controls current of each phase to impose current superimposing of two phases. Further, the asymmetric bridge converter is suitable for high voltage and large capacity and has relatively low rated voltage of a switch.

However, the switch control apparatus for the above-mentioned two phase SRM needs two wire leader lines for each phase and the wires have a complicated connection of wires, which increases a difficulty in a circuit design.

### PATENT DOCUMENT

Korean Patent Laid-Open Publication No. 2010-0115209

### SUMMARY OF THE INVENTION

The present invention has been made in an effort to provide a switching control apparatus and a method thereof capable of reducing the number of wire leader lines of a two phase switched reluctance motor while maintaining diversity of a control independent of a current control of each phase.

According to a first preferred embodiment of the present invention, there is provided a switching control apparatus for a two phase switch reluctance motor, including: a rectifier rectifying commercial power; and an active converter including a pair of common switches commonly connected to two phase windings of two phase SRMs, a pair of first phase switches bridge-connected to the pair of common switches at any one of the two phase windings, a pair of second phase switches bridge-connected to the pair of common switches at the other one of the two phase windings, and a plurality of current feedback diodes each connected to the switches, wherein the active converter is operated in operation modes 1 to 3 to provide the power rectified by the rectifier to the two phase SRM and drive the two phase SRM.

The switching control apparatus for a two phase switch reluctance motor may further include: a microprocessor sensing a position and a speed of the two phase SRM to control the active converter.

The pair of common switches may be configured of an upper common switch and a lower common switch connected with each other in series and the two phase windings of the two phase SRM is connected to a contact thereof, the pair of first phase switches may be configured of an upper first phase switch and a lower first phase switch connected with each other in series and any one of the two phase windings of the two phase SRM is connected to a contact thereof, and the pair of second phase switches may be configured of an upper second phase switch and a lower second phase switch connected to each other in series and the other one of the two phase windings of the two phase SRMs is connected to a contact thereof.

The upper first common switch and the lower first phase switch may be turned-on and be operated in operation mode 1 for any one phase winding of the two phase SRM, and the lower first common switch and the upper second phase switch may be turned-on and be operated in the operation mode 1 for the other one phase winding of the two phase SRM.

The current feedback diode connected to the lower first common switch and the current feedback diode connected to the upper first phase switch may be operated in the operation mode 2 for any one phase windings of the two phase SRM, and the current feedback diode connected to the upper first common switch and the lower second phase switch may be turned-on and be operated in the operation mode 2 for any one phase winding of the two phase SRM.

The current feedback diode connected to the upper first phase switch may provide a circulating path of residual current in a state in which the upper first common switch is turned-on and is operated in an operation mode 3 for any one phase winding of the two phase SRM, and the current feedback diode connected to the upper first common switch may provide the circulation path of the residual current in a state in which the upper second phase switch is turned-on and is operated in the operation mode 3 for any one phase winding of the two phase SRM.

The microprocessor may perform a control to change the active converter from the operation mode 1 to the operation mode 3.

The microprocessor may perform a control to change the active converter from the operation mode 1 to the operation mode 2 and the operation mode 3.

The microprocessor may perform a control to repeat a process in which the active converter is changed from the operation mode 1 to the operation mode 2.

According to a second preferred embodiment of the present invention, there is provided a switching control method for a two phase switch reluctance motor, including: (A) controlling, by a microprocessor, an active converter including a plurality of switches bridge-connected to each phase winding of a two phase SRM and a plurality of current feedback diodes each connected to the switches to excite any one of the phase windings and remove residual current; and (B) controlling, by the microprocessor, the active converter to excite the other one phase winding and remove the residual current.

The plurality of switches may include: a pair of common switches commonly connected to two phase windings of two phase SRMs; a pair of first phase switches bridge-connected to the pair of common switches at any one of the two phase windings; and a pair of second phase switches bridge-connected to the pair of common switches at the other one of the two phase windings.

In the control of the active converter of the steps (A) and (B), the microprocessor may perform a control to change the active converter from the operation mode 1 to the operation mode 3.

In the control of the active converter of the steps (A) and (B), the microprocessor may perform a control to change the active converter from the operation mode 1 to the operation mode 2 and the operation mode 3.

The microprocessor may perform a control to repeat a process in which the active converter is changed from the operation mode 1 to the operation mode 2.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of a switching control apparatus for a two phase switched reluctance motor according to a first preferred embodiment of the present invention;

FIG. 2 is a detailed configuration diagram of a rectifier and an active converter of FIG. 1;

FIGS. 3A to 3C are diagrams showing operation modes 1 to 3 for an A phase winding of the active converter;

FIGS. 4A to 4C are diagrams showing operation modes 1 to 3 for a B phase winding of the active converter;

FIG. 5 is a waveform diagram for describing a first switching type of the active converter of FIG. 1;

FIG. 6 is a waveform diagram for describing a second switching type of the active converter of FIG. 1;

FIG. 7 is a waveform diagram for describing a third switching type of the active converter of FIG. 1; and

FIG. 8 is a flow chart of a switching control method for the two phase switched reluctance motor according to the first preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

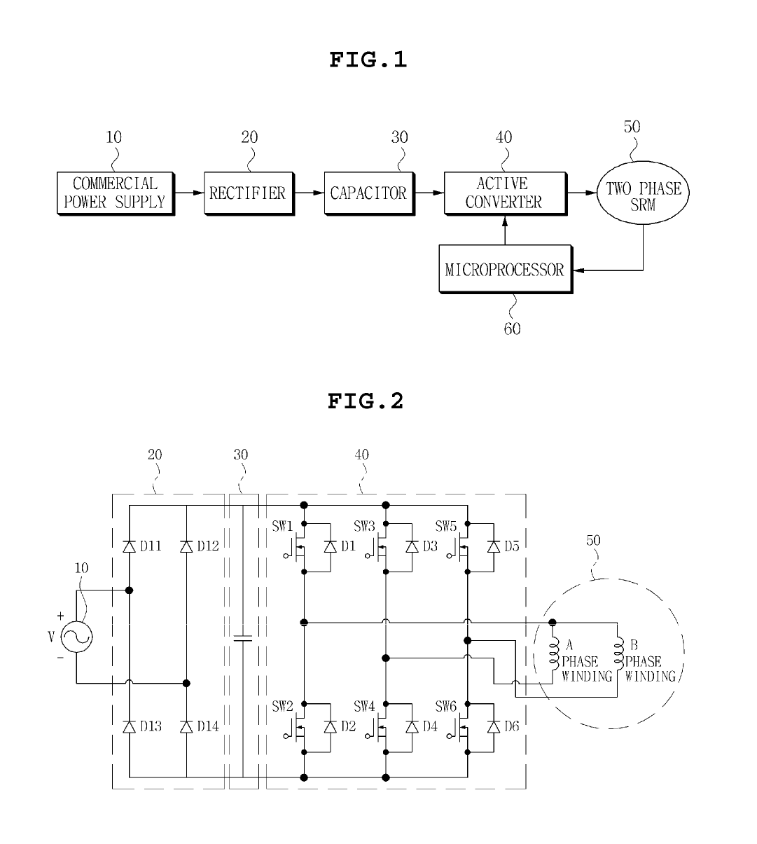

FIG. 1 is a configuration diagram of a switching control apparatus for a two phase switched reluctance motor according to a first preferred embodiment of the present invention.

Referring to FIG. 1, a switching control apparatus for a two phase switch reluctance motor according to a first preferred embodiment of the present invention is configured to include a rectifier 20 that rectifies commercial power 10 and supplies DC power, a capacitor 30 that is connected to the rectifier 20, an active converter 40 that is connected to the capacitor 30, and a microprocessor 60 that senses a position and a speed of a two phase SRM 50 to control the active converter 40.

The rectifier 20 rectifies the input commercial power 10 and supplies the rectified power to the capacitor 30. Further, the capacitor 30 improves a power factor of the rectified voltage and absorbs noise and supplies the commercial power to the active converter 40.

The active converter 40 includes: a pair of common switches commonly connected to two phase windings of two phase SRM 50; a pair of first phase switches bridge-connected to the pair of common switches at any one of the two phase windings; a pair of second phase switches bridge-connected to the pair of common switches at the other one of the two phase windings; and a plurality of current feedback diodes each connected to the switches, wherein the active converter is operated in the operation modes 1 to 3 according to a control of the microprocessor 60 to drive the two phase SRM 50.

Meanwhile, the microprocessor 60 senses the position and speed of the two phase SRM 50 to control the pair of common switches, the pair of first phase switches, and the pair second phase switches of the active converter 40, such that the switches are operated in the operation modes 1 to 3, thereby driving the two phase SRM 50.

Herein, the operation mode 1 applies positive reference voltage to the corresponding phase winding of the two phase SRM 50 to increase current flowing in a winding, the operation mode 2 circulates current to the winding when current flows in the winding to slowly reduce current, and the operation mode 3 applies negative reference voltage to the corresponding phase winding to rapidly reduce current.

The switching control apparatus for the two phase switched reluctance motor configured as above is operated as follows.

First, the microprocessor 60 controls the active converter 40 to be operated in the operation modes 1 to 3 to excite any one of the two phase windings of the two phase SRM 50 and then, end the exciting state.

Continuously, the microprocessor 60 controls the active converter 40 to be operated in the operation modes 1 to 3 to excite the other of the two phase windings of the two phase SRM 50 and then, end the exciting state.

Next, the microprocessor 60 repeatedly performs the operation to drive the two phase SRM 50.

In this case, the microprocessor 60 controls the active converter 40 to be operated in the operation modes 1 to 3 and can control the active converter 40 in various types.

For example, the microprocessor 60 controls the active converter 40 using a first switching type that performs a control to change the operation mode 1 to the operation mode 3, a second switching type that performs a control to change the operation mode 1 to the operation mode 2 and the operation mode 3, or a third switching type that performs a control to change the operation mode 1 to the operation mode 3, again to the operation mode 1, and again to the operation 3, and repeats the operation modes 1 and 3.

FIG. 2 is a detailed configuration diagram of a rectifier and an active converter of FIG. 1.

Referring to FIG. 2, the rectifier 20 shown in FIG. 1 is configured to include a diode bridge rectifier configured of four diodes D11 to D14 and rectifies the input commercial power 10 and supplies the rectified commercial power to a capacitor 30.

Further, the capacitor 30 improves a power factor of the rectified voltage and absorbs noise and supplies the commercial power to the active converter 40.

The active converter 40 is configured to include a pair of common switches SW1 and SW2 commonly connected to the A phase winding and the B phase winding; a pair of first phase switches SW3 and SW4 bridge-connected with the pair of common switches SW1 and SW2 at the A phase winding, a pair of second phase switches SW5 and SW6 bridge-connected with the pair of common switches SW1 and SW2 at the B phase winding, and 6 current feedback diodes D1 to D6 each connected to each of the switches SW1 to SW6, wherein the active converter 40 drives the two phase SRM 50 according to the microprocessor 60.

Herein, the plurality of switches SW1 to SW6 are each implemented by MOSFETs (in addition to this, BJT, relay switch, and the like). In this case, the plurality of current feedback diodes D1 to D6 may each be configured of body diodes reversely connected between drains and sources of the corresponding MOSFETs. In this case, the body diodes cannot be separated from each other due to inherent characteristics of the MOSFET.

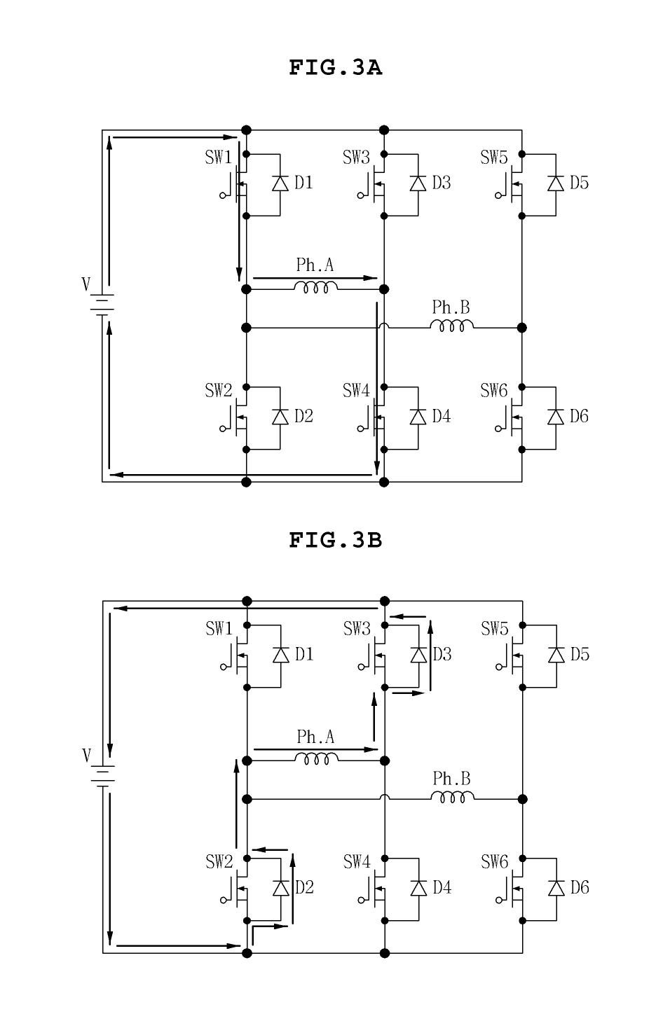

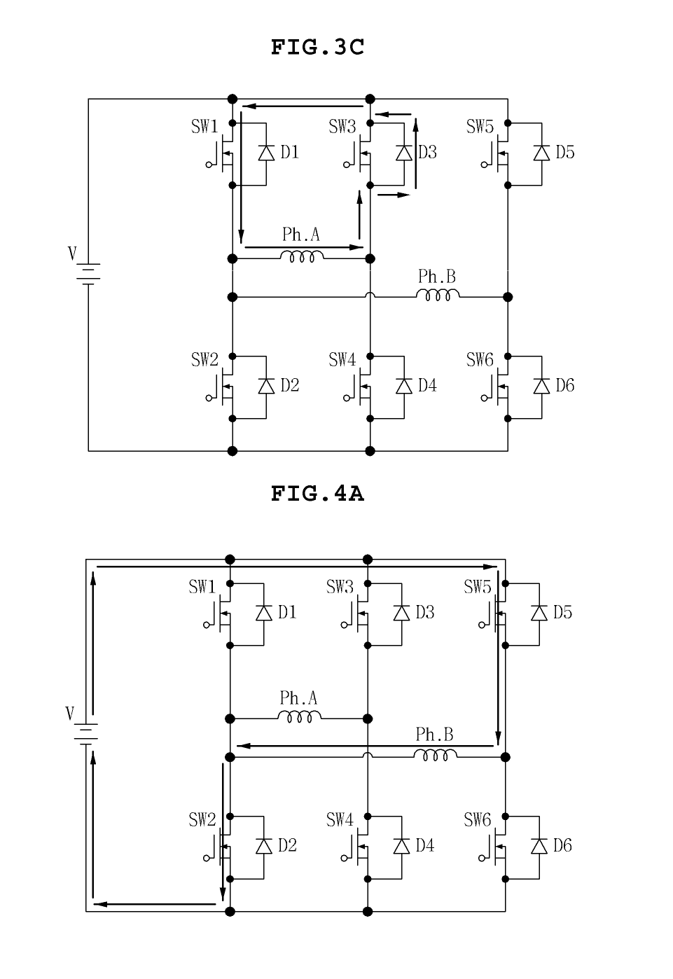

In the configuration of the active converter 40, as shown in FIG. 3A, one SW1 of the common switches SW1 and SW2 and one SW4 of the pair of first phase switches SW3 and SW4 are switched-on and is operated in the operation mode 1, thereby exciting the A phase winding.

In addition, as shown in FIG. 3B, one D2 of the current feedback diodes D1 and D2 that are formed in the pair of common switches SW1 and SW2 and one D3 of the current feedback diodes D3 and D4 that are formed in the pair of first phase switches SW3 and SW4 are used to return the residual current to the power supply side.

Further, as shown in FIG. 3C, when one SW1 of the common switches SW1 and SW2 of the active converter 40 is switched-on, one D3 of the current feedback diodes D3 and D4 that are formed in the pair of first phase switches SW3 and SW4 is operated in the operation mode 3, thereby circulating the residual current of the A phase winding.

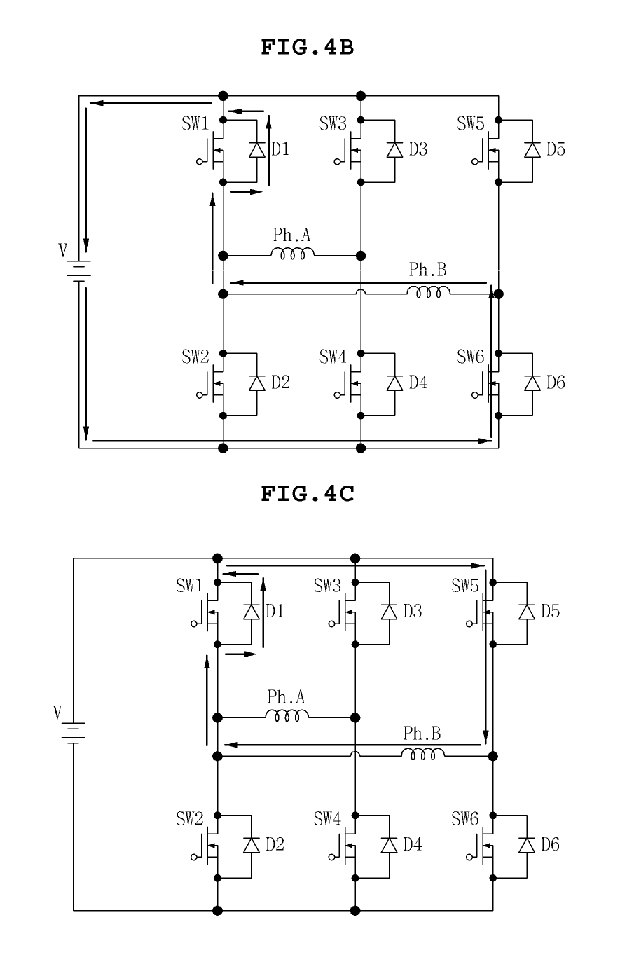

Similarly, as shown in FIG. 4A, even in the case of phase B, one SW2 of the pair of common switches SW1 and SW2 and one SW5 of the pair of second phase switches SW5 and SW6 are switched-on and is operated in the operation mode 1, thereby exciting the B phase winding.

In addition, as shown in FIG. 4B, one D1 of the current feedback diodes D1 and D2 that are formed in the pair of common switches SW1 and SW2 and one D6 of the current feedback diodes D5 and D6 that are formed in the pair of second phase switches SW5 and SW6 are used to return the residual current to the power supply side.

Further, as shown in FIG. 4C, when one SW5 of the second phase switches SW5 and SW6 of the active converter 40 is switched-on, one D1 of the current feedback diodes D1 and D2 that are formed in the pair of common switches SW1 and SW2 is operated in the operation mode 3, thereby circulating the residual current of the B phase winding.

As described above, modes 1 to 3 are formed by cooperating the pair of common switches SW1 and SW2 and the pair of first phase switches SW3 and SW4 and modes 1 to 3 are formed by cooperating the pair of common switches SW1 and SW2 and the pair of second phase switches SW5 and SW6, thereby performing various controls.

For example, the switching control apparatus for the switched reluctance motor uses the first switching type using modes 1 and 3.

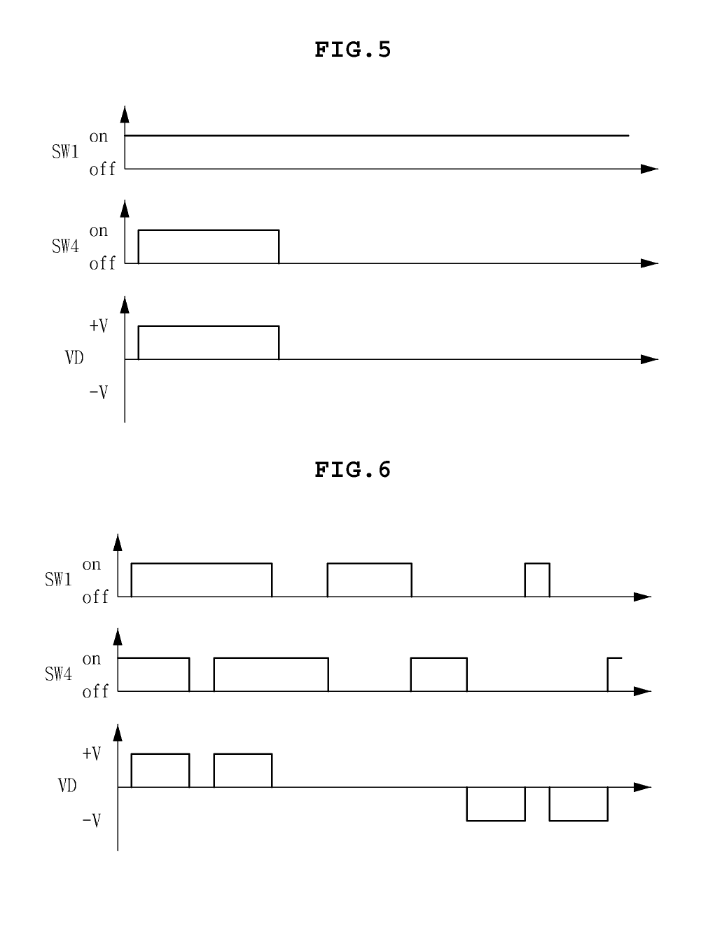

Describing this in more detail, as shown in FIG. 5, the switching control apparatus switches-on the upper common switch SW1 of the common switches SW1 and SW2 and the lower first phase switch SW4 of the pair of first phase switches SW3 and SW4 switches-on to be operated in the operation mode 1, such that voltage VD is applied to the A phase winding as reference voltage V, thereby exciting the A phase winding.

Next, as shown in FIG. 5, the upper common switch SW1 of the common switches SW1 and SW2 is maintained in a turn-on state and the lower first phase switch SW5 of the pair of first phase switches SW3 and SW4 is turned-off after the predetermined time lapses to change the operation mode from the operation mode 1 to the operation mode 3, thereby circulating the residual current to the A phase winding through the current feedback diode D3 connected to the first phase switch SW3. Thereafter, current induced to the A phase winding is converged to 0 over time.

The operation is similarly applied even to the B phase. First, the switching control apparatus switches-on the lower common switch SW2 of the common switches SW1 and SW2 and the upper second phase switch SW5 of the pair of second phase switches SW5 and SW6 switches-on to be operated in the operation mode 1, such that the reference voltage is applied to the B phase winding, thereby exciting the B phase winding.

Thereafter, the upper second phase switch SW5 of the pair of second phase switches SW5 and SW6 is maintained in a turn-on state and the lower common switch SW2 of the common switches SW1 and SW2 is changed to a turn-off state after the predetermined time lapses to change the operation mode from the operation mode 1 to the operation mode 3, thereby circulating the residual current to the B phase winding through the current feedback diode D1 connected to the upper common switch SW1. Thereafter, current induced to the B phase winding is converged to 0 over time.

According to the first switching type, the reference voltage and 0 voltage are applied to the phase winding, such that the following is well made in a current rising section and a flat section.

As another control type, the switching control apparatus may implement the second switching type using modes 1 to 3.

Describing this in more detail, as shown in FIG. 6, the upper common switch SW1 of the common switches SW1 and SW2 maintains a turn-on state for the predetermined time and the lower first phase switch SW4 is changed from a turn-on state to a turn-off state and again to a turn-on state and changes the operation mode from the operation mode 1 to the operation mode 3 and again to the operation mode 1 to apply the reference voltage to the A phase winding, thereby exciting the A phase winding.

Thereafter, the upper common switch SW1 is changed to a turn-off state and then, a turn-on state and again to a turn-off state. In this case, the lower first phase switch SW4 is reversely operated to be in the operation mode 3 state, thereby circulating the residual current of the A phase winding.

In addition, the lower first phase switch SW4 is maintained at the turn-off state and the upper common switch SW1 is changed from the turn-off state to the turn-on state and again to the turn-off state to be operated in the operation mode 2, the operation mode 3, and again in the operation mode 2, thereby returning the residual current of the A phase winding to the power supply side.

The operation is similarly applied even to the B phase. First, the lower common switch SW2 of the common switches SW1 and SW2 maintains a turn-on state for the predetermined time and the upper second phase switch SW5 is changed from a turn-on state to a turn-off state and again to a turn-on state during the period and changes the operation mode from the operation mode 1 to the operation mode 3 and again to the operation mode 1 to apply the reference voltage to the B phase winding, thereby exciting the B phase winding.

Thereafter, the lower common switch SW2 is changed to a turn-off state and then, a turn-on state and again to a turn-off state and the upper second phase switch SW5 is reversely operated to be in the operation mode 3 state, thereby circulating the residual current of the B phase winding.

In addition, the lower second phase switch SW6 is maintained at the turn-on state and the upper common switch SW1 is changed from the turn-off state to the turn-on state and again to the turn-off state to be operated in the operation mode 2, the operation mode 3, and again in the operation mode 2, thereby returning the residual current of the B phase winding to the power supply side.

The second switching type well performs the current following in the current rising period and the current falling period.

As another control type, the switching control apparatus may implement a third switching type using modes 1 to 3.

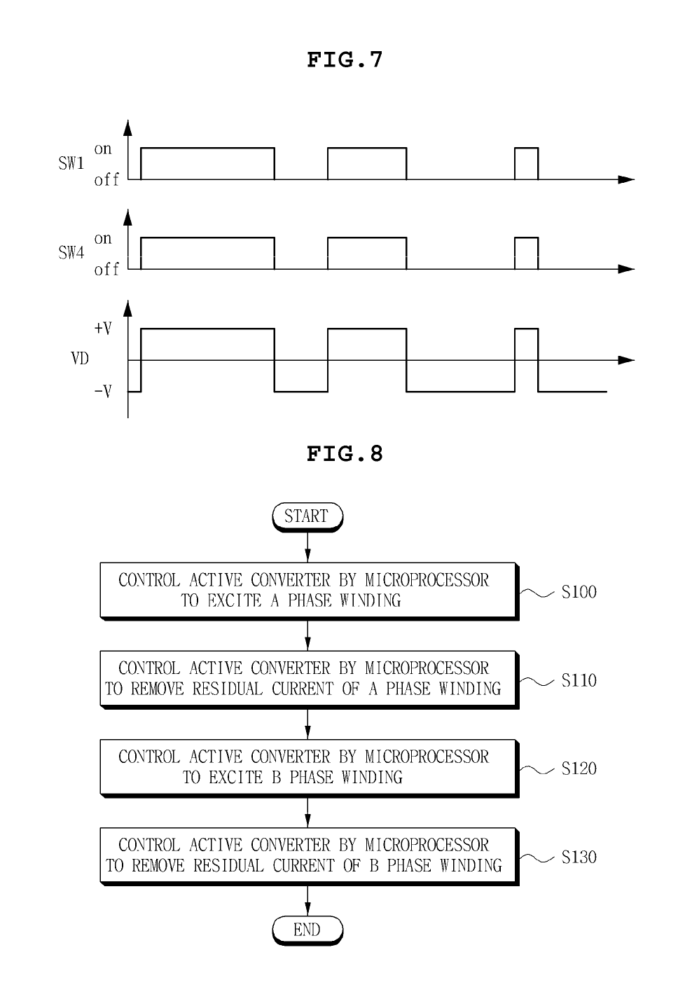

Describing this in more detail, as shown in FIG. 7, the upper common switch SW1 of the common switches SW1 and SW2 is turned-on and the lower first phase switch SW4 is turned-on and is in the operation mode 1 to apply the reference voltage to the A phase winding, thereby exciting the A phase winding.

Thereafter, the upper common switch SW1 and the lower first phase switch SW4 are turned-off after predetermined time lapses and is changed to the operation mode 3, thereby circulating the residual current to the A phase winding.

In addition, the upper common switch SW1 of the common switches SW1 and SW2 is turned-on and the lower first phase switch SW4 is turned-on after the predetermined time lapses and is in the operation mode 1 to apply the reference voltage to the A phase winding, thereby exciting the A phase winding. In this case, the turn-on time is shorter than the previous turn-on time.

Thereafter, the upper common switch SW1 and the lower first phase switch SW4 are turned-off when predetermined time lapses and is changed to the operation mode 3, thereby circulating the residual current to the A phase winding. In this case, the turn-off time is longer than the previous turn-off time.

In addition, the upper common switch SW1 of the common switches SW1 and SW2 is turned-on and the lower first phase switch SW4 is turned-on after the predetermined time lapses and is in the operation mode 1 to apply the reference voltage to the A phase winding, thereby exciting the A phase winding. In this case, the turn-on time is shorter than the previous turn-on time.

Thereafter, the upper common switch SW1 and the lower first phase switch SW4 are turned-off when predetermined time lapses and is changed to the operation mode 3, thereby circulating the residual current to the A phase winding. In this case, the turn-off time becomes residual time. The operation is similarly applied even to the B phase. Here, the lower common switch SW2 of the common switches SW1 and SW2 is turned-on and the upper second phase switch SW5 is turned-on and is in the operation mode 1 to apply the reference voltage to the B phase winding, thereby exciting the B phase winding.

Thereafter, the lower common switch SW2 is turned-off after the predetermined time lapses and the lower second phase switch SW6 is turned-on and is changed to the operation mode 3, thereby circulating the residual current to the B phase winding.

In addition, the lower common switch SW2 of the common switches SW1 and SW2 is turned-on and the upper second phase switch SW5 is turned-on after the predetermined time lapses and is in the operation mode 1 to apply the reference voltage to the B phase winding, thereby exciting the B phase winding. In this case, the turn-on time is shorter than the previous turn-on time.

Thereafter, the upper common switch SW1 is turned-off and the lower second phase switch SW6 is turned-on after the predetermined time lapses and is changed to the operation mode 3, thereby circulating the residual current to the B phase winding. In this case, the turn-off time is longer than the previous turn-off time.

In addition, the lower common switch SW1 of the common switches SW1 and SW2 is turned-on and the upper second phase switch SW5 is turned-on after the predetermined time lapses and is in the operation mode 1 to apply the reference voltage to the B phase winding, thereby exciting the B phase winding. In this case, the turn-on time is shorter than the previous turn-on time.

Thereafter, the lower common switch SW2 is turned-off and the lower second phase switch SW6 is turned-on after the predetermined time lapses and is changed to the operation mode 3, thereby circulating the residual current to the A phase winding. In this case, the turn-off time becomes residual time.

According to the bipolar switching type, it is possible to obtain current characteristics having excellent performance during a flat period.

Meanwhile, according to the preferred embodiment of the present invention, it is possible to reduce the number of wire leaders of the two phase switched reluctance motor from 3 to 2. Therefore, it is possible to simplify the connection of wires and has advantages in a circuit design.

In addition, according to the preferred embodiments of the present invention, it is possible to make the diversity of a control excellent by connecting four switches for each phase.

Further, according to the preferred embodiments of the present invention, it is possible to implement the current superimposing by performing the independent control for each phase.

Moreover, according to the preferred embodiments of the present invention, it is possible to commonly use the three phase inverter according to the prior art with the switching apparatus according to the present invention.

FIG. 8 is a flow chart of a switching control method for a switched reluctance motor according to the first preferred embodiment of the present invention.

Referring to FIG. 8, the microprocessor controls the active converter to excite the A phase winding of the two phase SRM (S100).

Next, the microprocessor controls the active converter to remove the residual current of the A phase winding of the two phase SRM (S110).

As the switching type that allows the microprocessor to control the active converter so as to perform the operation, there are the first switching type, the second switching type, the third switching type, and the like, as described above.

Here, according to the first switching type, the reference voltage and 0 voltage are applied to the phase winding, such that the following is well made in a current rising section and a flat section.

Further, the second switching type well performs the current following in the current rising period and the current falling period.

Next, according to the third switching type, it is possible to obtain current characteristics having excellent performance during a flat period.

The user selects types suitable for applications in consideration of advantages of the above-mentioned types and uses the microprocessor to operate the active converter by the corresponding type.

Continuously, the microprocessor controls the active converter to excite the B phase winding of the two phase SRM (S120).

Next, the microprocessor controls the active converter to remove the residual current of the B phase winding of the two phase SRM (S130).

As the switching type that allows the microprocessor to control the active converter so as to perform the operation, there are the first switching type, the second switching type, the third switching type, and the like, as described with reference to the A phase winding.

According to the preferred embodiment of the present invention as described above, even in the state in which the number of wire leaders of the two phase switched reluctance motor is reduced from 3 to 2, four switches are connected with each other for each phase, thereby making the diversity of control excellent.

Further, according to the preferred embodiments of the present invention, it is possible to implement the current superimposing by performing the independent control for each phase.

In addition, according to the preferred embodiment of the present invention, when the plurality of switches are each implemented by MOSFETs, the plurality of current feedback diodes can be implemented by the body diodes that are reversely connected between the drains and the sources of the corresponding MOSFETs, such that the separately isolated diodes are not required.

As a result, it is possible to save costs and increase the space utilization in the design.

Moreover, according to the preferred embodiments of the present invention, it is possible to commonly use the three phase inverter according to the prior art with the switching apparatus according to the present invention.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A switching control apparatus for a two phase switch reluctance motor, comprising:
a rectifier rectifying commercial power; and
an active converter including a pair of common switches commonly connected to two phase windings of two phase SRM, a pair of first phase switches bridge-connected to the pair of common switches at any one of the two phase windings, a pair of second phase switches bridge-connected to the pair of common switches at the other one of the two phase windings, and a plurality of current feedback diodes each connected to the switches, wherein the active converter is operated in operation modes 1 to 3 to provide the power rectified by the rectifier to the two phase SRM and drive the two phase SRM.

2. The switching control apparatus for a two phase switch reluctance motor as set forth in claim 1, further comprising: a microprocessor sensing a position and a speed of the two phase SRM to control the active converter.

3. The switching control apparatus for a two phase switch reluctance motor as set forth in claim 1, wherein the pair of common switches is configured of an upper common switch and a lower common switch connected with each other in series and the two phase windings of the two phase SRM is connected to a contact thereof,
the pair of first phase switches is configured of an upper first phase switch and a lower first phase switch connected with each other in series and any one of the two phase windings of the two phase SRM is connected to a contact thereof, and
the pair of second phase switches is configured of an upper second phase switch and a lower second phase switch connected to each other in series and the other one of the two phase windings of the two phase SRM is connected to a contact thereof.

4. The switching control apparatus for a two phase switch reluctance motor as set forth in claim 3, wherein the upper first common switch and the lower first phase switch are turned-on and are operated in the operation mode 1 for any one phase winding of the two phase SRM, and
the lower first common switch and the upper second phase switch are turned-on and are operated in the operation mode 1 for the other one phase winding of the two phase SRM.

5. The switching control apparatus for a two phase switch reluctance motor as set forth in claim 3, wherein the current feedback diode connected to the lower first common switch and the current feedback diode connected to the upper first phase switch are operated in the operation mode 2 for any one phase windings of the two phase SRM, and
the current feedback diode connected to the upper first common switch and the lower second phase switch are turned-on and are operated in the operation mode 2 for any one phase winding of the two phase SRM.

6. The switching control apparatus for a two phase switch reluctance motor as set forth in claim 3, wherein the current feedback diode connected to the upper first phase switch provides a circulating path of residual current in a state in which the upper first common switch is turned-on and is operated in the operation mode 3 for any one phase winding of the two phase SRM, and
the current feedback diode connected to the upper first common switch provides the circulation path of the residual current in a state in which the upper second phase switch is turned-on and is operated in the operation mode 3 for any one phase winding of the two phase SRM.

7. The switching control apparatus for a two phase switch reluctance motor as set forth in claim 1, wherein the microprocessor performs a control to change the active converter from the operation mode 1 to the operation mode 3.

8. The switching control apparatus for a two phase switch reluctance motor as set forth in claim 1, wherein the microprocessor performs a control to change the active converter from the operation mode 1 to the operation mode 2 and the operation mode 3.

9. The switching control apparatus for a two phase switch reluctance motor as set forth in claim 1, wherein the microprocessor performs a control to repeat a process in which the active converter is changed from the operation mode 1 to the operation mode 2.

10. A switching control method for a two phase switch reluctance motor, comprising:
(A) controlling, by a microprocessor, an active converter including a plurality of switches bridge-connected to each phase winding of a two phase SRM and a plurality of current feedback diodes each connected to the switches to excite any one of the phase windings and remove residual current; and
(B) controlling, by the microprocessor, the active converter to excite the other one phase winding and remove the residual current.

11. The switching control method for a two phase switch reluctance motor as set forth in claim 10, wherein the plurality of switches include:
a pair of common switches commonly connected to two phase windings of two phase SRMs;
a pair of first phase switches bridge-connected to the pair of common switches at any one of the two phase windings; and
a pair of second phase switches bridge-connected to the pair of common switches at the other one of the two phase windings.

12. The switching control method for a two phase switch reluctance motor as set forth in claim 10, wherein in the control of the active converter of the steps (A) and (B), the microprocessor performs a control to change the active converter from the operation mode 1 to the operation mode 3.

13. The switching control method for a two phase switch reluctance motor as set forth in claim 10, wherein in the control of the active converter of the steps (A) and (B), the microprocessor performs a control to change the active converter from the operation mode 1 to the operation mode 2 and the operation mode 3.

14. The switching control method for a two phase switch reluctance motor as set forth in claim 10, wherein the microprocessor performs a control to repeat a process in which the active converter is changed from the operation mode 1 to the operation mode 2.
